(19) United States
(12) Patent Application Publication
(10) Pub. No.: US 2024/0111310 A1
(43) Pub. Date: Apr. 4, 2024

(54) METHODS FOR UAV ROUTING COMBINING UAV FLIGHTS AND UAV ASSISTED TRAVEL

(71) Applicants: Ronan Xavier Ehasoo, Etobicoke (CA); Stuart Leslie Wilkinson, Etobicoke (CA)

(72) Inventors: Ronan Xavier Ehasoo, Etobicoke (CA); Stuart Leslie Wilkinson, Etobicoke (CA)

(21) Appl. No.: 18/129,316

(22) Filed: Mar. 31, 2023

Related U.S. Application Data
(63) Continuation-in-part of application No. 17/877,926, filed on Jul. 30, 2022, now Pat. No. 11,738,867.
(60) Provisional application No. 63/227,691, filed on Jul. 30, 2021.
(60) Provisional application No. 63/351,348, filed on Jun. 11, 2022.

(51) Int. Cl. G05D 1/667; B64U 70/00; B64U 80/25; B64U 80/82; B64U 80/84; B64U 80/86; G05D 1/697

(52) U.S. Cl. CPC G05D 1/667; B64U 70/00; B64U 80/25; B64U 80/82; B64U 80/84; B64U 80/86; G05D 1/697; B64U 2101/64; B64U 2201/10

(57) ABSTRACT

A method of carrying a UAV combined with a package on an assist vehicle (AV) in assisted travel mode over one route section, flying the UAV combined with a package over another route section, and carrying the UAV combined with the package on second AV in assisted travel mode over a third route section, the route sections being contiguous. Also, a method of flying a UAV combined with a package over one route section, carrying the UAV combined with the package on an AV in assisted travel mode over a second route section, and flying the UAV combined with the package over a third route section, the route sections being contiguous.

### CROSS REFERENCE TO RELATED PATENTS

The present application is a continuation-in-part application claiming priority from pending U.S. patent application Ser. No. 17/877,926, filed Jul. 30, 2022, entitled “Drone routing combining autonomous flight and assist vehicle travel”, which claims priority pursuant to 35 U.S.C. 119(e) from U.S. Provisional Patent Application Ser. No. 63/227,691 filed Jul. 30, 2021 entitled “Drone charging system and method” and U.S. Provisional Patent Application Ser. No. 63/351,348 filed Jun. 11, 2022 entitled “Combined autonomous assisted delivery drone travel”.

### FIELD OF THE INVENTION

The present invention relates to unmanned aerial vehicles (UAVs) or drones carrying packages. In this specification: the term “package” is intended to cover payload, parcel, material, objects, supplies, etc.; the term “UAV” is intended to cover any unmanned aerial vehicle (UAV) including multi-rotor and vertical take-off and landing (VTOL) aircraft, any such vehicle having a fixed wing to generate lift, and any such vehicle under remote or autonomous control, or any combination of remote and autonomous control.

With an increasing amount of on-line purchasing, the use of drones, particularly package-carrying drones, is expected to proliferate leading to sky congestion. Paralleling this is the proliferation of the ubiquitous ‘white van’ for package pick-up and delivery, leading to greater road congestion. This is especially the case for ‘last mile’ delivery, but is a growing problem also for ‘first mile’ and intervening travel.

### BRIEF DESCRIPTION OF THE DRAWINGS

FIG. 1 illustrates a route followed by a combination of an unmanned aerial vehicle (UAV) with a package, part of the route being in flying mode by the UAV and part of the route being assisted mode travel of the UAV on an assist vehicle (AV).

FIG. 1A illustrates a route followed by a combination of a UAV with a package, parts of the route being in flying mode by the UAV over first and second route sections, and a part of the route being by assisted mode travel of the UAV on an AV on a route section intermediate the first and second route sections.

FIG. 1B illustrates a route followed by a combination of a UAV with a package, parts of the route being in assisted mode travel over first and second route sections respectively on first and second UAVs, and part of the route being in flying mode by the UAV over an intermediate route section.

FIG. 2 illustrates a part of a journey similar to the journey of FIG. 1, but showing a route section where package pick-up by, and drop-off from, the UAV is by a hook device.

FIG. 3 illustrates a part of a journey similar to the journey of FIG. 1, but showing a route section where there is transfer of the UAV plus package from one AV to another AV.

FIG. 3A illustrates a UAV arriving at a site, combining with a package, and launching from the site.

FIG. 3B illustrates a UAV combined with a package arriving at a site, separating from a package, and launching from the site.

FIG. 3C illustrates a UAV traveling on an AV in assisted travel mode separating from its package, flying a side mission, and then returning to the AV to combine with its package.

FIG. 4 illustrates a part of a journey similarly to the journey of FIG. 1, but showing a route section where the package travels on an AV without being carried by a UAV.

FIG. 5 shows a high-level block diagram of a computing system for implementing an exemplary embodiment of the present invention.

FIG. 6 shows inputs and outputs (I/Os) to a UAV, an AV and a control center, selection of from the I/Os being applicable to different embodiments of the invention.

FIG. 7 is a representation of an electrically powered UAV carrying a package.

FIG. 8 is a representation of a combustible fuel powered UAV carrying a package.

FIG. 9 is a side, part-sectional view of a tractor unit trailing a container, the container receiving a landing UAV for assisted mode drive.

FIG. 10 is a top view of the tractor unit trailing container of FIG. 9.

FIG. 11 is a side, part-sectional view of a top part of the container of FIG. 9 showing a landed UAV parked within an upper chamber of the container.

FIG. 12 is a view similar to FIG. 11, but showing several UAVs within the chamber stacked for storage.

FIG. 13 is a view similar to FIG. 11, but showing UAVs within the chamber arranged for recharging or refueling.

FIG. 14 shows a side view construct of a railway locomotive and wagons pulled thereby illustrating different embodiments of the invention.

FIG. 15 is an isometric view of an arrangement for mounting UAV accommodating bays at the back of a container forming part of an AV, the AV being in assisted travel mode.

FIG. 16 is a view similar to FIG. 15, but showing the UAV mounting arrangement being manipulated to allow access to the container rear doors.

FIG. 17 is a view similar to FIG. 15, but showing the UAV mounting arrangement allowing full access to the container rear doors.

FIG. 18 is an isometric view of a container corner casting for use in a mounting arrangement according to an embodiment of the invention.

FIG. 19 is an isometric view of a container showing the location of the corner castings of FIG. 18.

FIG. 20 an isometric view of an anchor frame for use in mounting the UAV accommodating bays of FIG. 15 to the rear of a container.

FIG. 21 an isometric view of an interconnected anchor frame and clamping frame for use in mounting the UAV accommodating bays of FIG. 15 to the rear of the container.

FIG. 22 shows a rear part of the container of FIG. 15 with an interconnected anchor frame and clamping frame.

FIG. 23 is an isometric view of another arrangement for mounting UAV accommodating bays at the back of a container forming part of an AV, the AV being in assisted travel mode.

FIG. 24 is a view similar to FIG. 23, but showing UAV accommodating bays at the back of a container for an AV, the AV shown in a condition allowing container door opening and closing.

FIG. 25 is an isometric view of the arrangement of FIG. 23.

FIG. 26 is a perspective view of a landed UAV on a platform showing elements of a UAV holding and charging arrangement, such elements shown in an undeployed state.

FIG. 27 is a view similar to FIG. 26, but showing the UAV holding and charging elements in a deployed state.

FIG. 28 is an isometric view of a distribution tray and sliding mechanism for use in lateral shifting of the platform of FIG. 26.

FIG. 29 shows a configuration of bays for the arrangement of FIG. 26.

FIG. 30 is a view similar to FIG. 29, but showing a particular configuration where a UAV is preparing to land.

FIG. 31 shows a schematic view of a process for setting a UAV course with a view to the UAV landing at a moving AV.

FIG. 32 is a plan view of a UAV in a landed configuration on an AV platform together with elements of the platform, according to an embodiment of the invention.

FIG. 33 is an isometric view of the UAV of FIG. 32, showing further elements of the AV, including a UAV collapsing mechanism shown undeployed, according to an embodiment of the invention.

FIG. 34 is a view corresponding to FIG. 33, but showing the showing the UAV collapsing mechanism ready for deployment.

FIG. 35 is a view showing part of the view of FIG. 34, but showing the UAV collapsing mechanism deployed and UAV legs clamped.

FIG. 36 is view corresponding to FIG. 32 but showing the UAV collapsed and clamped.

FIG. 37 is a scrap view of part of a UAV core used in the embodiment of FIGS. 32 to 36.

FIG. 38 is a scrap view of part of a rotor supporting arm used in the embodiment of FIGS. 32 to 36.

FIG. 39 is a side view of a UAV package according to an embodiment of the invention.

### DETAILED DESCRIPTION OF THE INVENTION INCLUDING THE PRESENTLY PREFERRED EMBODIMENTS

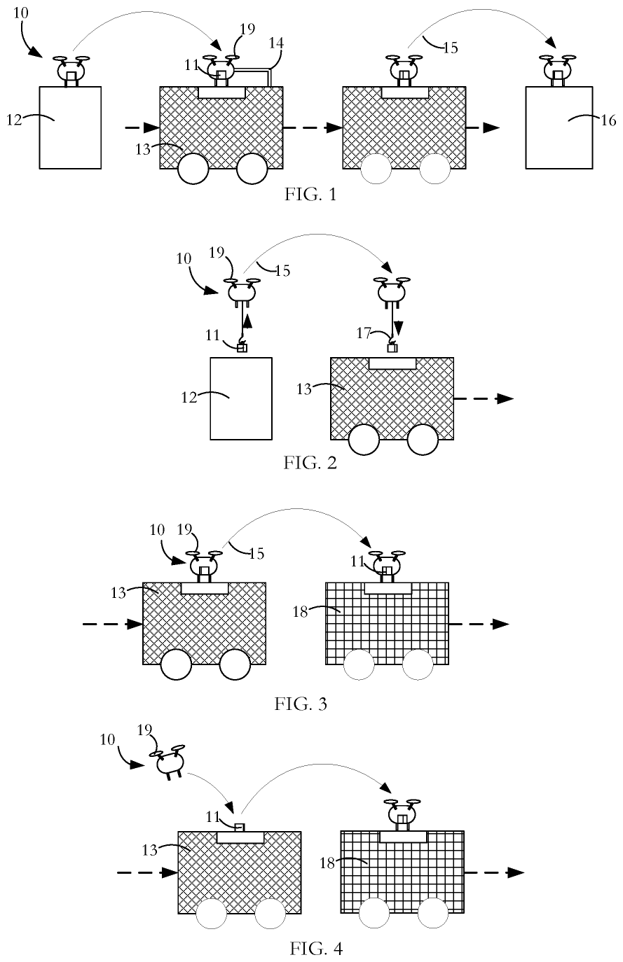

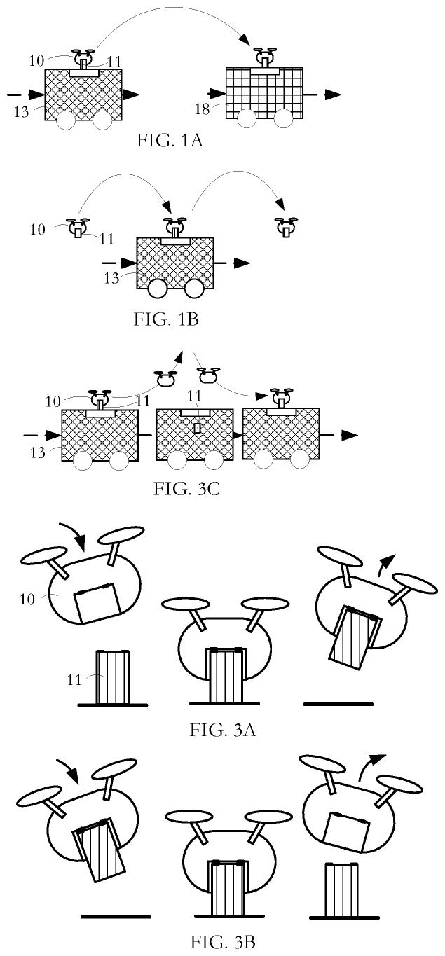

Referring to FIG. 1, in one form of the invention, an unmanned aerial vehicle (UAV) or drone 10 bearing a package 11 takes a combination flying mode/assisted mode journey. This begins with the UAV at a store, depot, or similar start location 12 being loaded with the package 11, the UAV 10 launching, the UAV 10 flying to an assist vehicle (AV) 13, the UAV landing at the AV 13 where optionally it is recharged/refueled 14, the UAV then being transported by the AV 13 in an assisted travel mode over a subsequent part of the route. At an appropriate location 15 during AV assisted mode travel, the UAV 10 launches from the AV 13, and flies to a location 16 where the package 11 is delivered. In an additional example, FIG. 1A shows carrying a UAV 10 combined with a package 11 on an AV 13 in assisted travel mode over one route section, flying the UAV 10 combined with the package 11 over another route section, and carrying the UAV 10 combined with the package on a second AV 18 in assisted travel mode over a third route section, the route sections being contiguous. In a further example, FIG. 1B shows flying a UAV 10 combined with a package 11 over one route section, carrying the UAV 10 combined with the package 11 on an AV 13 in assisted travel mode over a second route section, and flying the UAV 10 combined with the package 11 over a third route section, the route sections being contiguous. An AV may be one designed for transport on land, such as road or rail, by water or by air. The mode of transport of the one AV 13 may be the same as, or different from, the mode of transport of the second AV.

Package pick-up and delivery may be done after the UAV 10 lands or when the UAV is hovering over a target location (FIG. 3).

In a corded drop or pick-up, a hook 17, articulating gripper or like device is lowered from the hovering UAV 10 and raised to the hovering UAV 10, with the package 11 being loaded onto the hook 17 (pick-up) or unloaded from the hook 17 (delivery) when the hook is in a down position. In an alternative, delivery is by a parachute drop.

In further alternatives as shown in FIGS. 3A and 3B, the UAV has a housing in which are mounted electromagnets. An upper packaging panel of the package 11 incorporates corresponding electromagnets. In a package pick-up, where the UAV and the package become combined, FIG. 3A, the UAV flies to and lands at a position where the housing is over the package and the magnets on the housing are close enough to engage the electromagnets on the package. In a package drop-off, where the UAV and the package become separated, FIG. 3B, the UAV combined with the package flies to a landing position where the electromagnets, or some of them, are switched off to sever the magnetic engagement between the UAV and the package. The package stays at rest on the landing platform and the empty drone is launched.

In other alternatives, the UAV and the package can have one of more mechanical couplers having first coupling members mounted to the UAV and corresponding coupling members mounted to the AV. In one example, to separate and combine the UAV and package, engagement and disengagement of the mechanical coupling members are effected in response to prescribed movements of the UAV relative to the package. In another example, electromechanical couplings are used, with coupling member engagement and disengagement effected by, for example, solenoid and pin arrangements.

In s further embodiment, as shown in FIG. 3C, a UAV 10 traveling in assisted mode on an AV 13 is separated from the package 11 with which it is combined (left part of figure), whereupon the AV 13 is free to fly a side mission unencumbered by the package 11. The UAV 10 then returns to the AV 13 and is recombined with its package 11. This is especially useful where the AV 13 is for example, a train halted for a while in a station siding or a truck overnighting at a highway services. An advantage of side missions is that the UAV is utilized when it would otherwise be idle: this offers corresponding compensation to the UAV operator. The undertaking of side missions is readily integratable into a network for controlling operations of multiple UAVs and AVs.

In this specification, landing and launching are intended to cover procedures in which a package can be picked up or dropped off by a UAV at a start location, end location, or AV location, whether or not the UAV actually lands at the site to make the pick-up or drop-off.

Referring to FIG. 2, a combination flying mode/assisted mode journey may include a transfer leg. In a transfer leg, a package-carrying UAV 10 enjoying assisted travel on a first AV 13 is instructed to launch from that AV and to fly to and land at a second AV 18 for onward assisted travel.

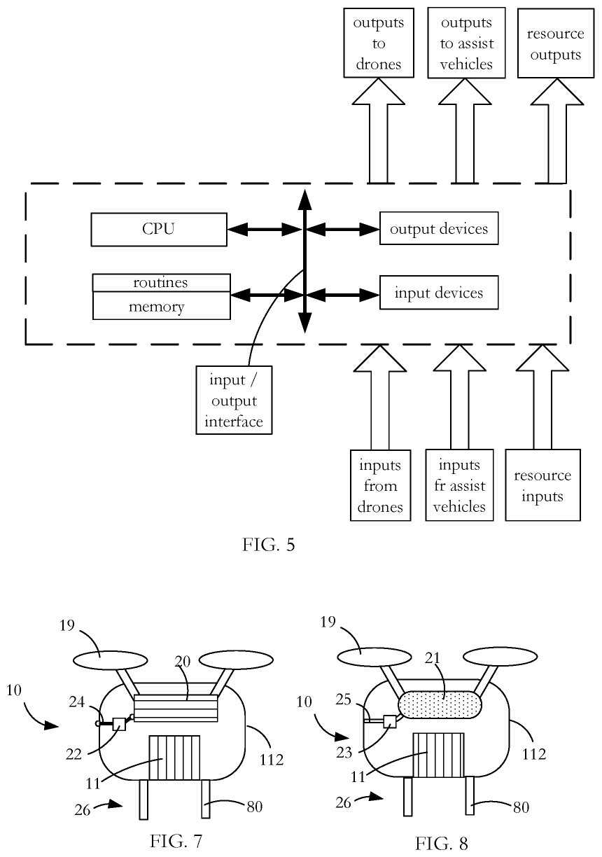

In a variation (FIG. 4) of the transfer leg, the package 11, owing to prior travel history, is traveling while secured at one AV 13 without being attached to a UAV. The AV 13 is met by a UAV 10—either landing or hovering—which, following release of the package 11 at the AV, picks up the package 11 and flies it to meet another AV 18 (or to a delivery point). The UAV 10 lands with the package 11 at the AV 18 for onward assisted travel (or to deliver the package). In a reverse of this variation, the UAV and its package are enjoying assisted mode travel on a first AV, the UAV launches and flies with the package to a second AV onto which it drops the package, where the package is robotically secured. The package then travels in assisted travel mode on the second AV without, for at least a time, being attached to a UAV.

A UAV route includes one or more launches from, and landings at, an AV or AVs. For both launching and landing, the AV is designed or adapted to offer launching- and landing-friendly structure and conditions. For landing, typically, UAV flight is controlled to halt the UAV over a landing site and then to undergo a controlled stall in order to drop and land. UAV landing gear has resilient or other shock absorbing elements to soften the landing and to avoid, to the extent possible, shock damage to the UAV or to a carried package.

The main hardware systems of a UAV are its flight control system, its rotor to generate lift and thrust, and linking frame parts. The UAV body may also house or incorporate a package compartment or package holder, and landing gear. The main elements of the flight control system are, typically, a global positioning system (GPS) by which the UAV can identify its position in space, its compass system which determines the UAV direction of travel, and its inertial measurement unit (IMU) system, which is used to stabilize the UAV's rotational attributes. A UAV receives signals at a GPS receiver from GPS satellites and uses the received information to calculate the UAV three-dimensional position and current time. GPS data are an important reference used for route selection and navigation (including launching and landing), etc. Sensors at the UAV are used to sense any of proximity to objects including AVs and landing/launching platform, orientation, UAV energy capacity, local weather elements, etc. Sensor output may be used locally at the UAV, for example to effect UAV manoeuvring, or may be transmitted from an on-board transmitter wirelessly to an AV or control center. The structure and operation of the UAV flight control system are incidental to the invention and will not be described in detail.

For the purposes of the present invention, the UAV can have any of (a) cameras for obtaining images to assist navigation or for other purposes; (b) sensors (i) for sensing proximity of objects, local weather, and atmospheric conditions, and (ii) sensors integrated into subsystems for control purposes; (c) a cargo bay, corded hook, articulating gripper or a similar mechanism for carrying packages.

Control software for communication and for UAV maneuvering, including launching, flying, and landing, may be centralized, or distributed. System control hardware and software also includes elements for use in gripping, holding, and releasing a package. Each of the UAV gripping, holding, releasing sub-systems may, as appropriate, include motors, such as linear and rotary motors, switches, solenoids, sensors, including contact and pressure sensors, detectors, cameras, drivers and the like. Elements of the system control hardware and software may be located, as appropriate and depending on various factors, at the UAV, at an AV or at a control center.

In one form, the UAV is controlled remotely from a control center having a wireless network link to a receiver at the UAV. Data transmitted over the link for the control of various sub-systems at the UAV may include any or all of data and instructions for navigation, manoeuvring, engine operation, landing, launching, UAV part folding/collapsing (and unfolding/extending), articulating UAV parts for holding/releasing packages, UAV power source replenishment, etc. As an alternative to central control, elements of control may alternatively, for necessity or convenience, be located out towards the edge of the control network. In some instances, some of the software (including firmware) for each of the operations identified above is located and operated at the UAV itself. Similarly, in one form of the invention, an operation to occur at the AV is controlled remotely from the control center (or a different control center) having a wireless network link to a receiver at the AV.

FIG. 5 shows a high-level block diagram of a computing system for implementing an exemplary embodiment of the present invention. The computing system includes system hardware and software for setting a route for a package, being a combination of a package carrying UAV flying over one or more route sections, and the UAV and package being carried over one or more AV assisted travel route sections, from a start location to an end location. The computing system also includes hardware and software, for initiating the route that is set and for completing the route subject to any route changes that are necessary or advantageous owing, respectively to problems and opportunities that are encountered along the way. Hardware and software are also included for (a) performing package-associated manoeuvres, and (b) enabling communication between elements and sub-systems of the system. The computing system may use known computer processors, memory and storage devices, software (including firmware) and other components. The computing system may include a central processing unit (CPU), memory and an input/output (I/O) interface. The I/O interface receives and transmits various inputs and outputs to and from one or more UAVs, to and from one or more AVs, to and from one or more control centers, and from resource centers.

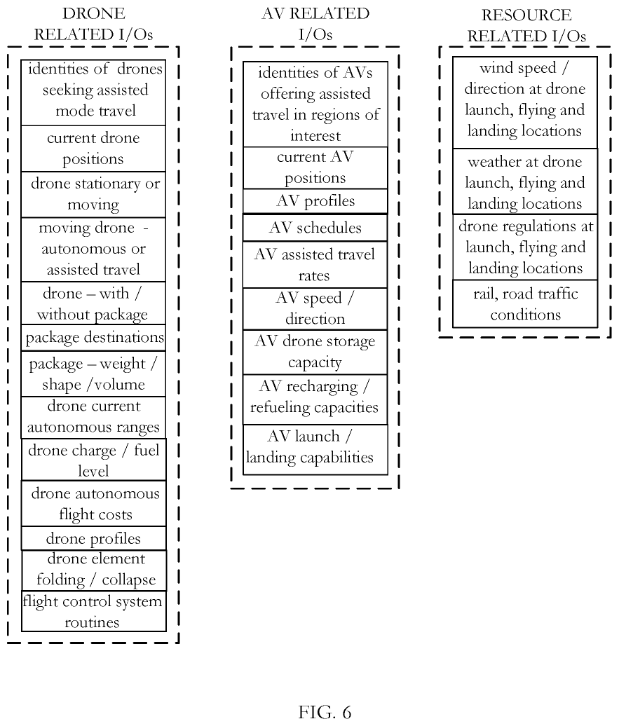

Resource centers include any or all of centers issuing weather conditions, traffic conditions, flying regulations and any other information pertinent to the package and UAV traversing the set route. I/Os may also be from and to devices enabling manual user interaction with the computing system. Sample I/Os to and from a UAV, an AV and a control center are listed in FIG. 6. Embodiments of the invention may use all or a subset of the I/Os depending on the specific nature of the embodiment. The listed I/Os are not intended to be limiting.

Support circuits may include circuits such as cache, power supplies, clock circuits, and a communications bus. The computing system may include stored routines which are executed by the CPU to process signal from the various possible signal sources. The computer can be a general-purpose computer system that becomes a specific purpose computer system when executing a routine. The computer can communicate with one or more networks such as a local area network (LAN), a general wide area network (WAN), and/or a public network (e.g., the Internet) via a network adapter. The computer may contain additional components as well, beyond those shown in the high-level example illustrated at FIG. 5. The computing system may also include an operating system and micro-instruction code. The various processes and functions described may either be part of the micro-instruction code or part of the application program, or a combination of the two, which is executed via the operating system. Various other peripheral devices may be connected to the computing system. Examples of well-known computing systems, environments, and/or configurations that may be suitable for use with the computing system include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Flight control technologies in conjunction with advanced connectivity systems may be used to transmit telemetry and flight control data from cell towers.

FIGS. 7 and 8 show exemplary UAVs 10, each having four rotors 19 (of which two are visible), respective drive units 20, 21, respective power sources 22, 23 replenishment units 24, 25, and landing gear 26. Each UAV carries a package 11. The UAV of FIG. 6 has an electrical drive unit 20 and the power source 22 is a battery. The UAV of FIG. 7 has a combustible fuel source 23 and a corresponding combustible fuel drive unit 21. Any suitable fuel and associated fuel replenishment method is contemplated for a UAV to be used in the invention, including battery, gas, gas-electric, hydrogen fuel cell, solar, and hybrids using multiple energy sources.

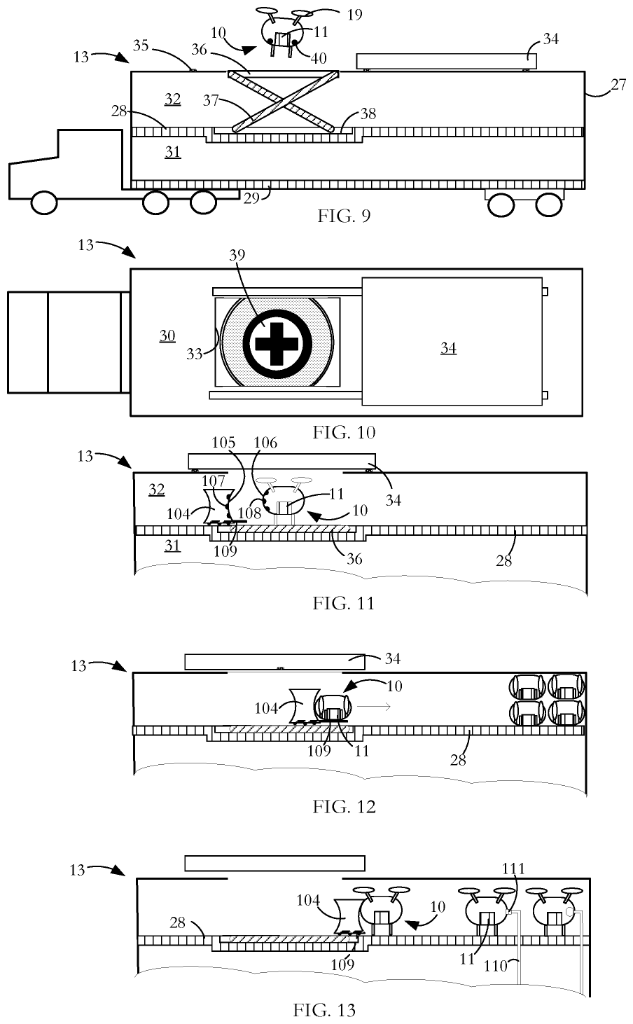

The AV can be any vehicle designed or adapted to transport a UAV in assisted drive mode, meaning that a UAV can be launched from, and landed at, the AV. An AV may be one designed for transport on land, such as road or rail, by water or by air. The invention finds particular application in vehicles as shown in FIG. 9 that transport a standardized ISO intermodal container 27 where the design or adaptation to transport the UAV in assisted mode is at the container itself. FIG. 8 shows a side, part-sectional view of such a container 27 coupled to a trailer of a tractor-trailer combination. The container 27 has an interior floor 28 located between the container main floor 29 and the container roof 30. Floor 28 divides the container interior volume into a lower chamber 31 for conventional container storage and an upper chamber 32 for transporting and re-charging UAVs. Floor 28 extends over the whole area of the container 27 but, in another form, may extend over just part of the area: for example, between parts of the container outer walls and an internal cross-wall (not shown).

As shown at FIG. 10, the container roof 30 has an aperture 33 that, in one implementation, extends over a little less than half the length of the container and extends across the container width except for margin regions 34. In other arrangements, such an aperture can be formed in a side, front or back panel of the container. The aperture 33 is rectangular but can be of any suitable shape, such as circular. The aperture can have an alternative configuration and/or size depending, for example, on the size and configuration of UAVs that are intended to pass though the aperture and depending, also, on expected difficulty in landing and launching.

As shown at FIGS. 10 and 11, a sliding door 34 has a weatherproof seal 35 at its mounting to the container roof 30 to protect the interior of the upper chamber 32 from adverse weather elements when the sliding door 34 is closed. The door 34 is normally closed (FIG. 11) to protect the interior, but is opened (FIG. 10) to allow a UAV 10 to land or launch. In one embodiment, door operation is under wireless control from an approaching UAV 10 seeking to land or from a stored UAV ready for launch. In an alternative arrangement, the door is hinged. In another alternative, the door is mounted under the level of the roof and slides inside the upper chamber 32.

Referring to FIG. 9, a platform 36 is mounted on a scissor-type extension arrangement 37 which can be retracted from the elevated position of FIG. 8 to a fully lowered position shown in FIG. 10. In the fully lowered position, the elements of the extension arrangement 37 and the platform 36 are supported within a housing 38 so that when the extension arrangement 37 is in its lowest position, the platform top surface is co-planar with the top surface of floor 28. In this way, UAVs can be slid easily onto and off the platform 36 and along floor 28. Among alternative platform elevators, particularly for a road vehicle with an on-board hydraulics system, the platform elevator uses a hydraulic jack.

Although, as shown in FIG. 9, the platform 36 can be elevated to the container roof 30, the elevator can alternatively raise the platform 36 above the level of the container roof 30 to reduce the incidence of potential obstructions to UAV launching and landing. In another form, where, for example, the AV is halted and there is great confidence in the precision of the UAV's launching and landing procedures, the elevator rises only to a low height or the elevator is eliminated altogether. In the latter, the platform 36 is fixed at the level of floor 28, and UAV launching and landing are executed in a hover mode with the UAV rising or descending through the aperture 33.

As shown in the top view of FIG. 10, the platform 36 bears a sighting pattern 39 for use in conjunction with cameras 40 at the UAV 10 to facilitate precise landing of the UAV onto a desired landing spot. The sighting and use of the pattern by the cameras 40 during landing uses a control procedure linked to dynamic image processing software. In an alternative, the sighting pattern is on the UAV and the cameras are on the platform.

Referring to FIGS. 11 to 13 showing a top part of the container 27, there is shown a holding mechanism 104 for engaging with a UAV 10 that has landed on platform 36. In this specification, a ‘holding mechanism’ means a mechanism for grasping or attaching itself temporarily to the UAV and for pushing or pulling the UAV along the floor to a desired position in another part of the upper chamber. In the embodiment illustrated, the holding mechanism is a Dalek™ type robot 104 which engages the UAV 10 at a part 105 that is complementary in shape to a part 106 of the UAV and which has attachment devices 107, 108, such as magnets, on the robot 104 and on the UAV 10. The robot 104 operates to attach itself to a landed UAV 10 and to maneuver the UAV to a storage site (FIG. 12) or a re-charging/refueling site (FIG. 13). At the storage site, the robot 104 is operable to further maneuver the UAV into a laterally stacked position or, using an extending and elevating mechanism 109, into a vertically stacked position. The holding mechanism 104 also operates in reverse to extract a UAV 10 from a stacked or refueling configuration and to move the extracted UAV across the floor 28 to a launch-ready position on the platform 36. In another alternative, the holding mechanism acts to encircle the UAV and to pull it across the floor from one position to another.

One position to which a UAV 10 can be moved by the robot 104 is an energy replenishment position as shown in FIG. 13. In one example, energy from an energy source on the AV electrically re-charges a UAV through a charge supply line 110 and mating electrical connectors 111—a charger-side connector at the AV and a UAV-side connector at the UAV. In one form, automated connection can use an adaptation of the charging system and method described in U.S. Pat. No. 11,370,317 (Babu et al.), the disclosure of which is hereby incorporated herein by reference for all purposes. Using an automatic charging device, a method for charging a UAV includes a camera at the AV capturing images of indicia on a parked UAV or on a UAV-side connector. The images are analyzed and based on the image position and orientation, the charger-side connector is moved (for example, movement in an x, y plane) from an initial position to a connection-ready x, y position. The charger-side connector is then driven along the z-axis to cause elements of the electrical connectors to matingly engage. In an alternative, the reference indicia are on the AV or the charger-side connector, and the UAV is moved to ready the connectors for engagement.

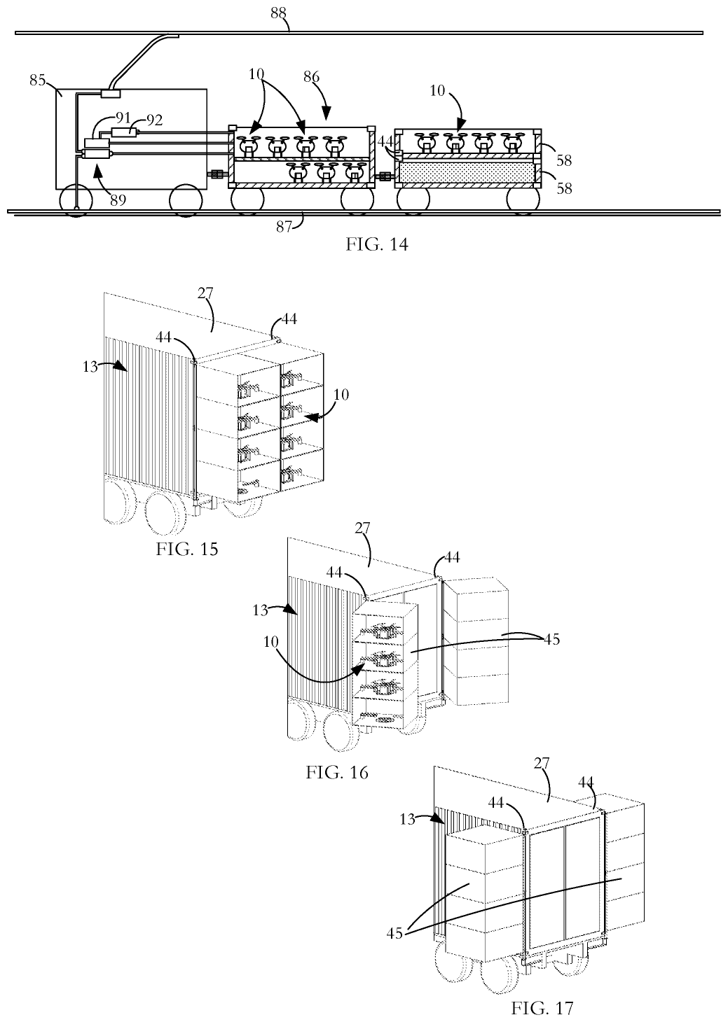

FIG. 14 is a composite representation of a train showing various UAV drive units/fuel sources have corresponding connection schemes. For example, for a UAV powered by a combustible fuel, the UAV has an inlet port 41 and a transfer pipe 42 for conveying fuel from the inlet port 42 to a storage tank 43 for an internal combustion drive. At the AV, fuel is pumped from a fuel source through another pipe to an outlet port. For fuel replenishment with the UAV parked at the AV, a guidance and connection arrangement is used which may be similar to the example described for electrical charging.

The replenishment system may include hardware, firmware, software for initiating, controlling, and ending each of the process steps previously described. Firmware and software elements may be distributed between the UAV, the AV and some other control location with appropriate linking communications hardware and software.

As shown in FIGS. 7 and 8, a package carrying UAV 10 has multiple drive rotors 19 and landing gear legs 80, both of which project some distance up and down respectively from the main UAV body 112 in order to permit effective flying, launching, and landing. Projecting rotors and landing gear are unnecessary and space-consuming when the UAV is being transported by an AV in assisted drive mode. Referring to FIG. 12, the several UAVs, as well as being stored in a compact arrangement, are themselves ‘compacted’.

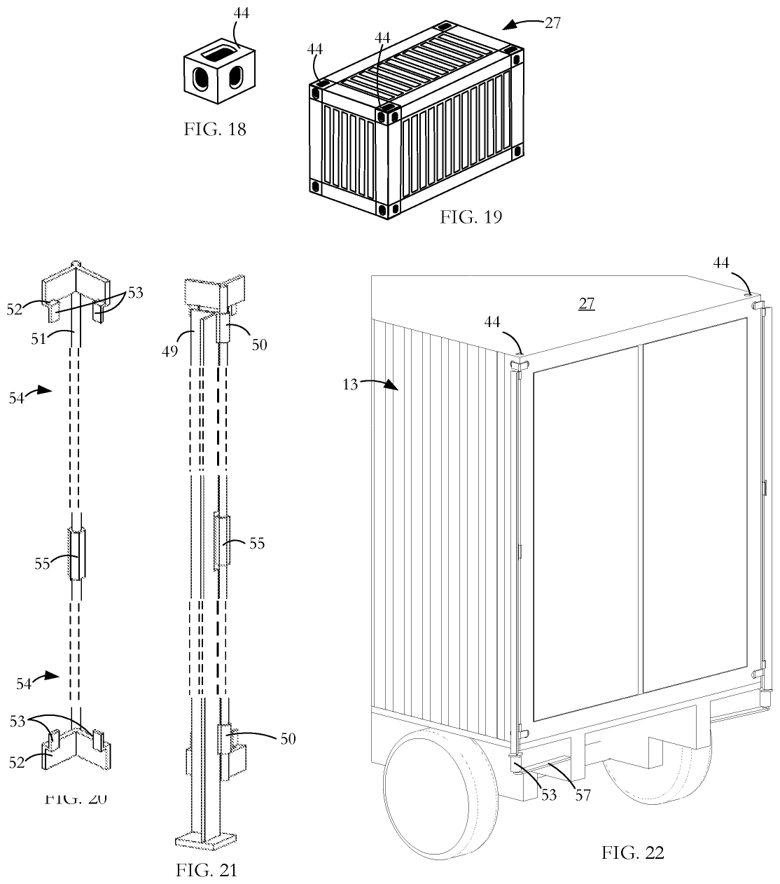

Referring to FIGS. 15 to 19, in another form of the invention, a UAV holder 45 is mounted at corner castings 44 at the back of an ISO intermodal container 27. The corner castings 44 are three-holed blocks of heavy-duty, weathering steel (FIG. 18) which form structural anchors at the corners of the container 27 (FIG. 19). The corner castings 44 are normally used for lifting containers and for connecting them to each other and to trailers of tractor trailers and goods wagons. The holder 45 (FIG. 15) has eight UAV bays 46, four commonly mounted on the left rear side of the container 27 and four commonly mounted on the right rear side. Each four-bay structure has a clamping frame 48 (FIG. 20) which connects to an anchor frame 47 as shown in FIG. 21. The anchor frame 47 has the interior of an angle beam 49 adapted to be welded or bolted to vertically aligned corners of the four bays 46. Welded to the exterior of the angle beam 49 at each end are sleeves 50 for slidably receiving cylindrical rods 51 of the clamping frame 48. The clamping frame is telescopic, having two parts 54, each formed by a rod 51 having a casting 52 welded to one end. The casting 52 has locking fingers 53 for insertion into respective side holes of a container corner casting 44. One clamping frame rod has a distal end section formed with a righthand thread and the other rod has its distal end section formed with a lefthand thread.

In use, to mount a four-bay UAV holder 45 to a container 27, an anchor frame 47 is attached to a clamping frame 48 by sliding the rods 51 of upper and lower clamping frame parts 54 respectively into the upper and lower sleeves 50 of an anchor frame 47 previously attached to the bays 46. The ends of the two aligned rods 51 are then loosely attached together with an elongate hex nut 55 having a lefthand thread on one end and a righthand thread on the other. The fingers 53 of the upper clamping frame part 54 are hooked onto the container top corner casting 44 and the fingers 53 of the lower clamping frame part 54, in inverted position, are hooked onto the corresponding bottom corner casting. The hex nut 55 is turned one way to draw the two clamping frame parts 54 tightly against the corner castings 44 and so tightly fix the UAV bays 46 at one rear side of the container 27. The same procedure is followed to mount bays 46 on the other rear side. At each side, a rotary motor 56 is operated to angularly turn an actuating arm 57 connected to the anchor frame 47 to hinge the corresponding bank of UAV bays 46 between different positions.

When the AV 13 is being driven on the highway as shown at FIG. 13, the four-bay UAV holders 45 are locked in the ‘closed’ position (FIG. 15). When the container 27 is stopped and access to the container rear doors is required, the holder is hinged (FIG. 16) from the closed position and locked in the ‘open’ position (FIG. 17). The hex nut 55 is turned the opposite way to loosen the clamping frame 48 from its corresponding corner castings 44 if the UAV holder bays 46 are to be removed completely from the AV 13.

Other forms of bay and arrangements of multiple bays are possible. For example, as shown at FIG. 19, among various ISO standardized containers are so-called half height containers which are 1.45 meters high and are used usually for dense cargo such as sand. A half height container 58 is configured as a dedicated multi-UAV transport module which is lowered onto and connected at its corner castings 44 to a second half-height container 58.

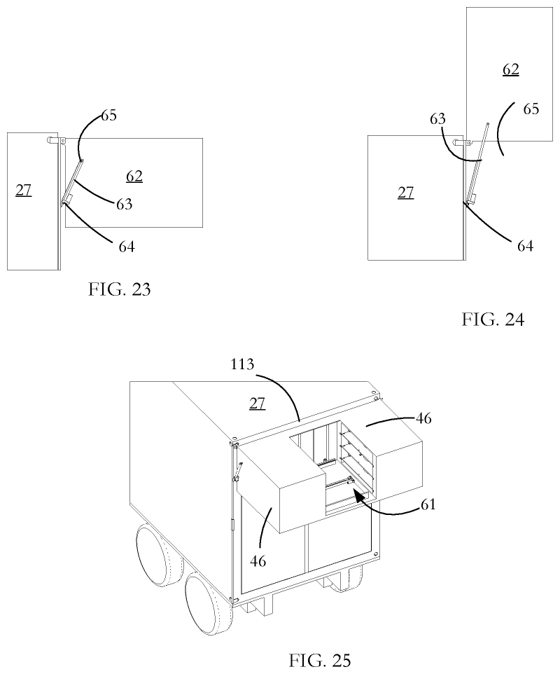

FIGS. 23 to 30 show an alternative arrangement for mounting a bank of UAV bays 46 at the rear of an intermodal container 27 forming part of an AV. In this case, there are two banks of bays positioned either side of, and integral with, a UAV landing and launching station 61. The station 61 and bays 46, as a unit 62, can be hinged between a lowered position (FIG. 23) in which the unit 62 is in front of the container rear doors, and a raised position (FIG. 24) in which the unit 62 clears the rear doors to allow their opening. The unit 62 is mounted to each side of the container 27 by a powered strut fitment 63 extending between an anchor part 64 integral with the container rear corner and a mounting 65 on the unit 62. The powered strut 63 includes a rotatable sleeve, an interior rod, an electric rotary motor and a compression spring (not shown). To hinge the unit 62 from its lower to its upper position, the rotary motor is activated and its motion is converted to linear movement of the rod within the sleeve against counterweight bias of the compression spring. This acts to push the unit 62 upwards and angularly about container hinge mounting 113 to the upper position where the powered strut 63 locks. Reverse motion is similar following unlocking.

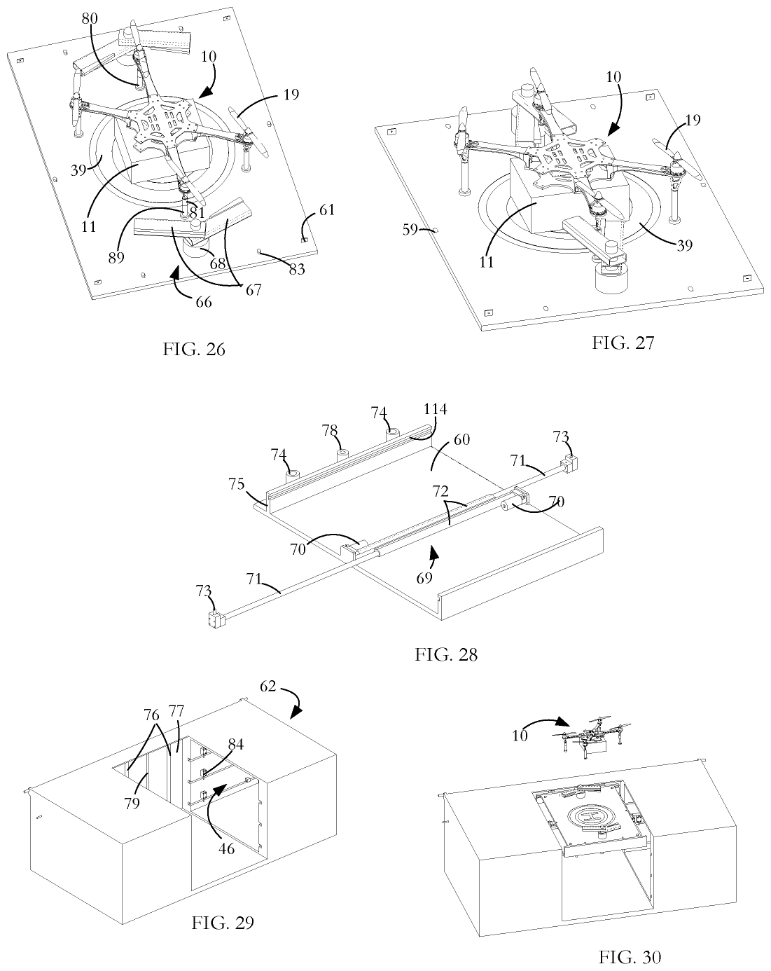

There are as many platforms 36 as there are bays 46 and each platform 36 has an associated holding mechanisms 66 (FIG. 26) for use both in holding a landed UAV and recharging it. While a structure and operation to hold, and a structure and operation to recharge, a UAV could be separately configured in a different embodiment, it is more convenient if they are combined. At each side of the UAV landing position on a platform 36 are a respective pair of metal bars 67, the bars pivotable at a mounting block 68 which houses a rotary motor (not shown) to drive the bars 67 between an open position (FIG. 26) and a closed position (FIG. 27). UAV landing is controlled such that opposed UAV legs 89 stand on the bisectors of the included angle between respective bar pairs. The platform 36 has charging posts 61 electrically connecting a charging system (not shown) forming part of the AV 13 to the bars 67.

For UAV maneuvers, such as landing, launching, and storing, performed at the central station 61, the associated platform 36 is retained at a central location in the distribution tray 60 (FIG. 28) by engagement of the platform 36 within channels 114 and within a sliding mechanism 69 mounted on the tray 60. The sliding mechanism 69 has linear motors 70 to slidably drive respective actuating rods 71 along their longitudinal axes through tubular bearings 72. The rods 71 have retractable pins 73 at their free ends which fit into respective slots 59 in the platform 36. One or other of the pins 73 is engaged in its corresponding slot 59 while the other pin is retracted so that the platform 36 can be driven into (or out of) a selected bay 46.

The tray 60 has bushings 74 integral with tray flanges 75 allowing the tray 60 to be slid up or down on linear shafts 76 (FIG. 29) integral with a rear wall 77 of the unit 62. To drive a platform 36 to the level of a particular bay 46, an acme nut 78 integral with tray flange 75 screw engages a centrally located acme rod 79 integral with the unit rear wall. The acme rod 79 is rotated about its axis to drive the platform 36 up or down.

In use, an empty platform 36 is extracted from one of the bays 46 and is elevated to the top of the station 61 to await the arrival of a flying UAV (FIG. 30), with the bars 67 being in the ‘home’ position (FIG. 26). The UAV 10 shown is a package-carrying, electrically powered UAV having six rotors and a six-legged landing gear. The landing procedure is implemented to land the UAV 10 accurately in relation to the bar angle bisectors. When completion of landing is sensed, the rotary motors at mounting blocks 68 are energized to angularly rotate the bars 67 to close the included angles and so bring the bars of each pair towards one another to the positions shown in FIG. 27. The closure of a bar pair both clamps the two UAV legs 89 to prevent any further movement of the halted UAV 10, and causes the bars 67 to make electrical contact with respective charging circuit terminals 81 on the clamped legs 89. Once the UAV is held at the platform 36, the elevating mechanism 78, 79 (FIGS. 28, 29) is actuated to bring the tray 60 to the desired bay level. Once at the right level, the sliding mechanism 69 is actuated to slide the platform 36 and landed UAV 10 into channels 82 at the selected bay 46. As the platform 36 reaches its fully inserted position, locking posts 83 on each side of the platform 36 are engaged by an over-center locking mechanism 84 mounted at the bay 46. The engaged pin 73 is then retracted and the applicable slide mechanism rod is withdrawn back into the central station. The platform 36, UAV 10 and package 11 are consequently locked at the selected bay 46 in preparation for an assisted drive leg of the journey and ready also for eventual hinging of the bank of UAVs 46 to the container door opening position (FIG. 24).

In a variation (not shown), particularly for single UAV assisted mode accommodation, the AV has an exposed platform; i.e., one not accommodated in a bay or compartment. The platform is attached to a panel or frame member of the AV and can be hinged between a horizontal position for UAV launching and landing and a substantially vertical position against the panel for storage for assisted mode travel. In the storage condition, a transported UAV is temporarily fixed to the platform shortly after the UAV lands while the platform is still in the horizontal condition and before the platform—with UAV attached—is stored. When the assisted mode travel leg is complete and the UAV is to be re-launched, the platform is robotically hinged from the storage position to the horizontal position, and the UAV is released from the platform just before the launch procedure takes place. The launch can be completed from the AV while it is still moving if conditions are conducive to that, or the AV is brought to a halt for the duration of the launching procedure. At the end of launching, the now-empty platform is hinged down to its storage position for onward travel of the vehicle. A locking mechanism is provided for automatically locking and unlocking the platform at deployed and storage positions.

Referring to FIG. 14, there is shown a schematic view of one form of AV—a train locomotive 85—towing a goods wagon 86. The AV is shown having several features which may not normally be seen together on a conventional locomotive, but are shown here on the same locomotive image for convenience of illustration. FIG. 14 illustrates a particular aspect of the invention: recharging or refueling possibilities during assisted mode travel. In one form, the locomotive 85 is electrically powered, with electricity being supplied to the locomotive drive unit through a rigid conducting rail—a so-called third rail 87—mounted either beside the train track or between the main rails of the track. In another form, the locomotive is electrically powered by an overhead line 88. In both cases, in addition to a main feed to the locomotive drive unit, a supplementary circuit and connection arrangement shown schematically as 89 is provided for recharging the batteries of UAVs 10 enjoying assisted drive in the wagon 86.

In a further form, for a locomotive 85 powered by a combustible fuel such as diesel, the fuel from the locomotive tank having a main feed to its drive unit and a supplementary feed and connection arrangement shown schematically as 91 for refueling internal combustion UAVs enjoying assisted drive in the wagon 86. In yet another form, for a locomotive 85 powered by a combustible fuel and electrically powered UAVs 10, fuel is fed through a supplementary line to drive an electrical generator 92 and a supplementary circuit and connection arrangement is provided from the generator 92 for recharging the batteries of following UAVs 10.

Energy replenishment schemes such as those described can be used with other electric AVs such as trams (including segmented ground-level powered trams), light transit, and other road, air- and sea-borne AVs with appropriate tailoring to adapt the replenishment scheme to the energy sources at the AV and at the UAV. Each of the replenishment schemes described may, as appropriate, include cables, pipes, switches, valves, regulators, sensors, drivers and the like, and control hardware and software for their operation.

In terms of speed of transfer between UAV flying mode and assisted travel mode, it may be quicker or more convenient if, for landing at and launch from the AV, the transfer is done while the AV is still moving rather than having to bring the AV to a halt to effect either of those procedures; i.e., a dynamic transfer. One description of such a system is found in Visual Servoing Approach for Autonomous UAV Landing on a Moving Vehicle, Keipour et al., which, together with the text of the references cited therein, is hereby incorporated by specific reference in this specification. While dynamic transfers may be implemented in ‘first mile’ or ‘last mile’ travel, such procedures may also occur in transferring a UAV and its package from one AV to another AV.

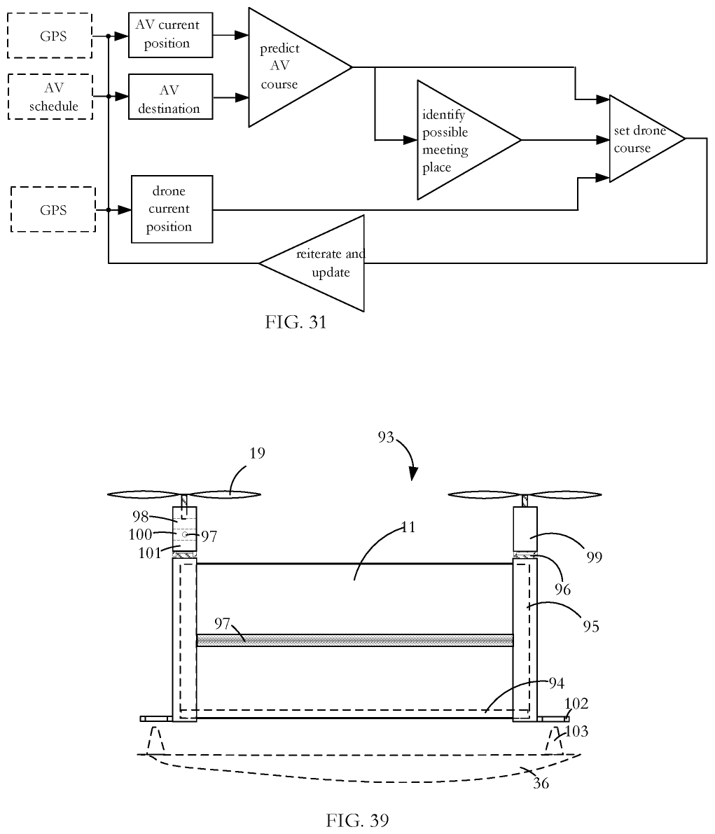

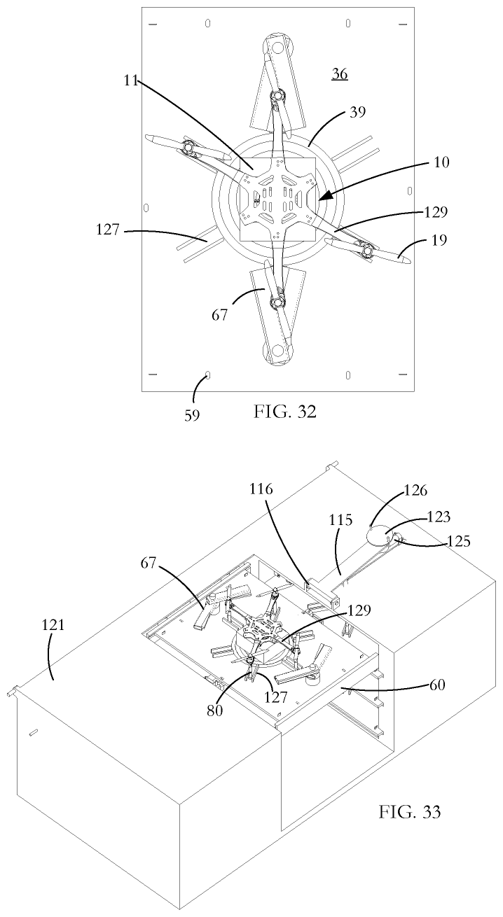

FIG. 31 shows an exemplary sequence for setting and updating a UAV course with a view to landing at an AV which is moving at the time of landing. The location of the UAV and the AV are registered at certain times. An AV course from its current position is predicted using GPS positions possibly supplemented by a known prearranged overall AV route. A possible UAV-AV ‘meeting place’ is identified and an initial course is set for the UAV. Input data is periodically updated and reentered and the course and meeting place are reset.

Landing and launching a UAV at an AV are difficult for many reasons and so, in most cases, it may be necessary or convenient to temporarily halt the AV before such a maneuver is implemented. In one form, an AV halt is pre-scheduled with knowledge of the halt time and location known to the UAV and that AV. In another form, communication is established between the AV and the UAV (or a control center) to set up the time and place of a halt or to check whether the AV has already been halted for an incidental purpose: for example, at a highway service center.

For a UAV ready to land at an AV, in one form, communication between the UAV and the AV or between the UAV and a control center is triggered by a proximity detector on the UAV. The UAV's presence and wish to land is communicated to the AV driver or to an AV drive unit. In response, in one example, the AV is brought to a halt while the UAV follows a flight course to land on the AV when it halts. In another example, an instruction is issued to the UAV to proceed to a selected meeting spot where the AV is to stop and the UAV is to land. This describes a sequence for flying a UAV to land at an AV; for example, in the context of a UAV with payload launching from a shop or depot and flying to and landing on an AV: a ‘first mile’ travel.

A reverse sequence is adopted for ‘last mile’ travel where a UAV plus package is traveling in assisted mode on an AV. As the AV enters a region of landing opportunity in which the UAV destination (being possibly, also, the final package destination) is located, an instruction is sent to the UAV to launch and a corresponding communication is sent to the AV driver (or AV drive unit) from the UAV or from a control center. In response, in one form, the AV is brought to a halt at a convenient or logistically preferred position in the region, whereupon the UAV launches. In another form, the UAV launches from the moving AV after due preparation and at a convenient or logistically preferred position in the region, with notification of the impending launch optionally being sent to the AV driver.

In yet another sequence, using elements of both the last mile and first mile sequences, the UAV launches from a first AV when that first AV is halted or is moving within a region of opportunity. Thereupon, the UAV flies to a second AV within a corresponding region of opportunity and lands, either after the second AV halts or while it is still moving.

Clearly, a landing spot or launching spot, whether for a dynamic or a halted transfer, must not be so far away from the UAV that the UAV is unable to fly to the spot because of its limited range.

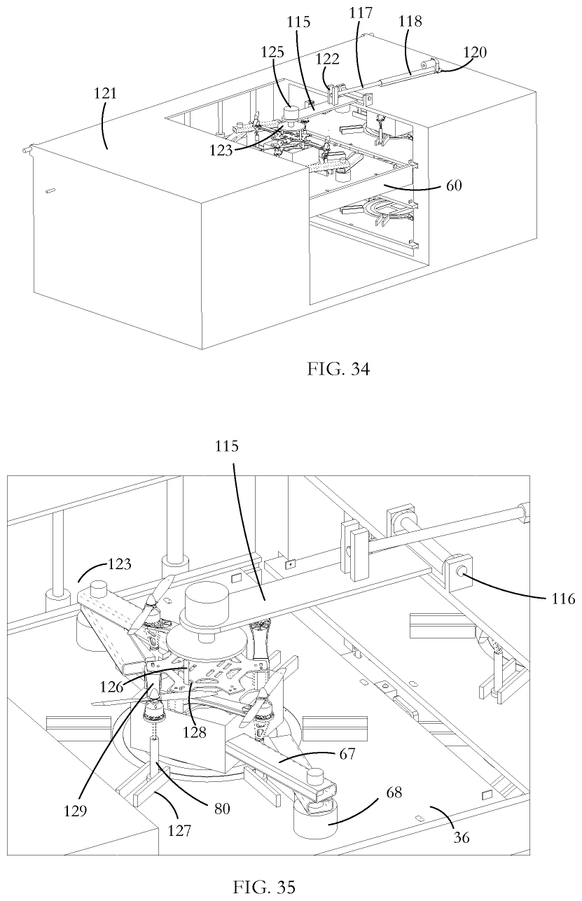

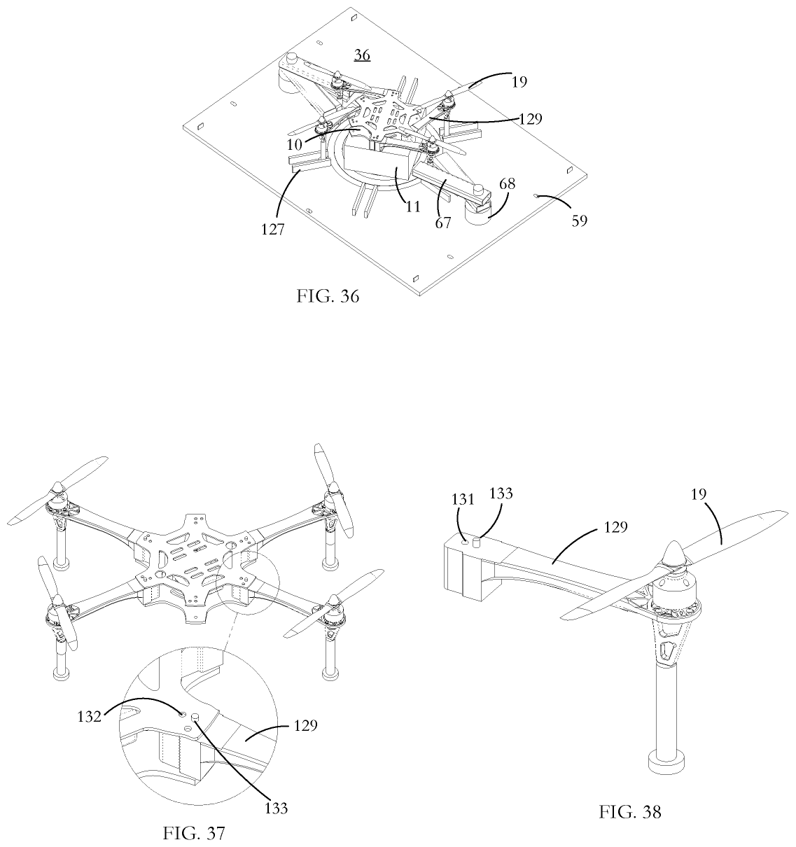

In one form of the invention, rotors and/or landing gear legs are mounted to the main body of the UAV using flexible or articulatable mountings. An articulated version is shown in FIGS. 33 to 38. Hingedly mounted to the top of a unit 121 of the form shown in FIG. 25 is an actuating arm 115. The arm 115 is driven to rotate about axis 116 between a home position (FIG. 33) and a deployed position (FIG. 34, 35) by operation of a rod 117 and cylinder 118 arrangement driven by motor 119. A fixed end of the cylinder 118 is mounted at point 120 on unit 121. The outer end of rod 117 is mounted between flanges 122 extending from arm 115. At the end of the arm 115, disc member 123 is drivably rotatable about its axis by a rotary motor 125. A pair of fingers 126 project from the disc member 123. When the UAV 10 is in the landed position of FIG. 35, the UAV legs 80 (four of which are shown) are received in channels 127 mounted to the platform 36. Hinging of the actuating arm 115 from the home position to the deployed position is such as to cause the fingers 126 to enter holes 128 (FIG. 35) in the UAV central structure. After engagement of the fingers 126, rotary motor 125 is operated to turn the disc member 123. In response, rotor supporting arms 129 where they are mounted to the disc member 123, are forced to move tangentially about the UAV central axis. Because movement of the outer ends of the supporting arms 129 and their depending legs 80 is constrained by the channels 127, they cannot tangentially track the movement of the mounting positions. The constraint causes the fingers 126 to move radially inwardly along channels 127 towards the UAV central axis, thereby hinging the rotor supporting arms 129 about their mounting positions and towards the core of the UAV. To permit this angular hinging, a spring mounted ball 131 in the top of each supporting arm (FIG. 38) and two ball retaining housings 132 in the UAV central structure (FIG. 37). As a supporting arm 129 is forced tangentially by the rotary motor 125, the inner end of the supporting arm 129 rotates about shaft 133 and forces the spring ball 131 downwards. The spring ball 131 is forced to unseat from one housing 132—a ‘flight’ housing—to allow movement of the supporting arm 129 from its landed position to a folded storage position, where the spring ball re-seats in the second housing 132—a ‘storage’ housing. The rotors 19 and the supporting arms 129 are folded against the UAV body when UAV storage is required and unfolded prior to launch. In this way, the overall storage volume of a UAV is reduced compared with its overall flight volume. UAV expansion is done by similarly engaging the UAV 10 with the actuating arm 115 and operating the rotary motor 125 to turn in the opposite direction. The ‘compacting’ of a UAV is useful for dense multiple storage in an AV bay. It is useful also for situations where the UAV is attached and transported at the exterior of an AV and where a smaller UAV profile will reduce wind resistance encountered during AV assisted mode travel. In another embodiment (not shown), the legs are mounted to permit them to be folded against the UAV body to further reduce overall UAV volume. In an alternative, elements of the UAV may be made of a flexible material to permit similar UAV volume reduction by bending and fixing such elements against the UAV body. In the embodiment described, volume reduction is done by an AV mechanism acting on elements of the UAV; in another form (not shown), volume reduction is done using a mechanism forming part of the UAV itself.

As mentioned with respect to FIG. 4, a mixed flying mode—assisted mode journey can be viewed as a journey of the carried package instead of a journey of the UAV. Referring to FIG. 39, there is shown what might be termed a UAV package 93. The figure shows one elevation but, in this case, the UAV package is a cuboid of square area and all other side elevations are substantially the same. Of note, there are no landing gear legs; the bottom of the package 93 acts as its own landing gear. The package itself projects down below all other elements of the structure and is reinforced, padded, and covered as necessary to ensure a soft landing with low damage risk to the UAV or package contents. The UAV package 93 accommodates a lightweight, corrugated, resiliently deformable mat 94 to cushion landing and has reinforcing, lightweight plastic angle structures 95 at each vertical corner. Above each angle corner 95 is a rotor 99 which is connected by a lightweight acme rod and nut combination 96 to the angle corner 95. A drive unit at the rotor 99 houses a battery 100 (or fuel tank) including a replenishment port 97, a drive train 98 and communications and control hardware and software 101. Because the rotors 99 are independently mounted, additional communication is required between them to assist in coordinating flying and maneuvering of the UAV package. The acme combination 96 has a pitch direction such that when the associated rotor 99 is spinning, inertial forces transmitted to the body of the rotor tend to resist any tendency for the acme combination to loosen. In another configuration, the angle corner 95 is differently configured to have linear compressibility and its top mounting is differently configured so that the inertial forces tend while the rotor is turning to apply, through the angle corners 95, a vertical clamping force between the package upper and lower reinforced corners. In another configuration, a clamping band 97 is used to pull adjacent angle corners together and against the package vertical corners as a final step in UAV package preparation. In a further configuration, a push connector joins a rotor 99 to an angle corner 95.

In assembling a UAV package, rotors 99 can be deployed with other packages of different area, can be configured with different included angles for use with triangular, pentagonal, etc., package shapes, and can be configured with any of several lengths to permit use with packages of different height. In one embodiment, the angle corner 95 has an outwardly projecting horizontal ring 102 used to set final placement of the UAV 10 as it lands on a platform 36. The ring 102 seats over an upwardly-projecting cone 103, one of an array of such cones formed on the platform 36 as shown in phantom in FIG. 29. In a further embodiment, when required, the cones are reciprocally vertically driven downwards against a spring bias to exit their surrounding UAV rings, thereby to clear the platform and allow the UAV to be subsequently slid off the platform and moved to a storage or energy replenishment site.

While control hardware and software, including communication hardware and software, can be distributed between the UAV and the AV, in another implementation, some of the processing and control is assigned to a control center. At the control center, which may itself be distributed—for example, between different cities—there may be the capability for intervention of a human operator. Such an individual may provide any of general oversight, troubleshooting logistical issues, and taking over in the event of an emergency or catastrophic failure somewhere in the system.

In the specification and claims, the designation of any method step as being first, second, third, etc., is not to be construed as setting a positional or temporal relationship between the steps.

Other variations and modifications will be apparent to those skilled in the art and the embodiments of the invention described and illustrated are not intended to be limiting. The principles of the invention contemplate many alternatives having advantages and properties evident in the exemplary embodiments.

What is claimed is:

1. A method comprising
flying an unmanned aerial vehicle (UAV) combined with a package over a first section of a route,
carrying the UAV combined with the package on a first assist vehicle (AV) in assisted travel mode over a second section of the route, and
carrying the UAV combined with the package on a second AV in assisted travel mode over a third section of the route, wherein said first section of the route is intermediate and contiguous with said second section of the route and said third section of the route.

2. A method comprising
flying an unmanned aerial vehicle (UAV) combined with a package over a first section of a route,
carrying the UAV combined with the package on an assist vehicle (AV) in assisted travel mode over a second section of the route, and
flying the UAV combined with a package over a third section of the route, wherein said second section of the route is intermediate and contiguous with said first section of the route and said third section of the route.

3. The method claimed in claim 1, further comprising flying the combined UAV and package over a fourth section of the route from a start location to the first AV, whereupon to start the carrying of the UAV and the package on said second section of the route.

4. The method claimed in claim 3, further comprising combining the UAV and the package at the start location preparatory to flying of the UAV combined with the package over the fourth section of the route.

5. The method claimed in claim 4, wherein the start location is at a third AV.

6. The method claimed in claim 4, wherein the start location is a fixed site.

7. The method claimed in claim 1, further comprising flying the combined UAV and package over a fourth section of the route from the second AV to a destination location.

8. The method claimed in claim 7, further comprising separating the package from the UAV at the destination location.

9. The method claimed in claim 7, wherein the destination location is at a third AV.

10. The method claimed in claim 7, wherein the destination location is a fixed site.

11. The method claimed in claim 1, wherein the first and second AVs carrying the UAV and the package in assisted travel mode is by a mode of travel which is any of rail, road, water, and air, and wherein the mode of travel of the first AV is the same as the mode of travel of the second AV.

12. The method claimed in claim 1, wherein the first and second AVs carrying the UAV and the package in assisted travel mode is by a mode of travel which is any of rail, road, water, and air, and wherein the mode of travel of the first AV is different from the mode of travel of the second AV.

13. The method claimed in claim 1, wherein, in said carrying the UAV and the package on at least one of the AVs, the UAV and the package are in an ISO intermodal container.

14. The method claimed in claim 1, wherein at least one of the AVs has a source of energy, the method further comprising connecting an energy outlet port at the first AV to an energy inlet port at the UAV over a period during the UAV and the package being carried in assisted mode travel by said at least one AV, and replenishing energy at the UAV from the source of energy at the at least one AV.

15. The method claimed in claim 1, wherein, during carrying of the UAV combined with the package on at least one of the AVs, separating the package from the UAV.

16. The method claimed in claim 15, wherein, after separating the package from the UAV, recombining the UAV and the package.

17. The method claimed in claim 16, the further comprising intermediate the separating and the recombining, flying the UAV on a side mission away from and back to the AV.

18. The method claimed in claim 1, further comprising landing the UAV combined with the package at the second AV following flying the UAV combined with the package over the first section of the route.

19. The method claimed in claim 1, further comprising launching the UAV combined with the package from the first AV prior to flying the UAV combined with the package over the first section of the route.

20. The method claimed in claim 1, wherein at least a part of the route flown by the UAV is autonomous flying.
